(19) United States
(12) Patent Application Publication
(10) Pub. No.: US 2008/0165976 A1
(43) Pub. Date: Jul. 10, 2008

(54) SYSTEM AND METHOD FOR STEREO SOUND FIELD EXPANSION

(75) Inventor: James Albert, Honesdale, PA (US)

Correspondence Address: GREENBERG TRAURIG, LLP, 2101 L Street, N.W., Suite 1000, Washington, DC, 20037, US

(73) Assignee: Altec Lansing Technologies, a Division of Plantronics, Inc., Milford, PA (US)

(21) Appl. No.: 11/620,514

(22) Filed: Jan. 5, 2007

(51) Int. Cl. H04R 5/04

(52) U.S. Cl. 381/18

(57) ABSTRACT

A system and method for enhancing the stereo sound effect produced by speaker systems having two or more speakers fed by two or more channels or audio, respectively. Second-order high pass filtering is applied to first and second audio signals of a stereo signal. A phase shift of approximately 180 degrees is applied to the resulting signals. A mixer mixes the processed first audio signal with the original second audio signal and mixes the processed second audio signal with the original first audio signal, whereby an expanded stereo sound field effect is created.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of stereo audio systems, and in particular to systems and methods for providing an enhanced stereo sound field.

### BACKGROUND OF THE INVENTION

Stereo separation is the ability of an audio system to reproduce the spatial location information of sound sources in an audio recording. During stereo recording, two or more microphones, in different locations, are typically used to record an acoustic source. The time delays and pressure differences between the audio signals from the microphones provide spatial information. The spatial information allows the listener to interpolate the location of the various sound sources in the recording. By contrast, a monophonic sound recording may contain the same detail of the recorded source, but will not contain the spatial information of stereophonic sound.

Various design factors may have a negative affect on stereo separation. For example, audio systems which have the right and left stereo speaker drivers in close proximity to each other can suffer from poor channel separation, which reduces the stereo sound field effect, yielding a sound that is more monophonic than stereophonic. Other factors that can negatively affect stereo separation include, but are not limited to, the physical design of the speaker enclosure, speaker placement within the enclosure, and sound processing techniques, including bass enhancement circuits or algorithms.

In audio systems that include two speaker drivers and a subwoofer, driving the speakers out of phase with respect to each other can be used to enhance the stereo sound field effect. This technique is generally disadvantageous, however, particularly in audio systems containing two speaker drivers without a subwoofer, because it can cause phase-related distortion of the low-frequency content due to the generally monophonic nature of such content; because the low-frequency signal is substantially the same in both the left and right channels, running the left and right speakers out of phase causes cancellation of desirable low frequencies.

Various electrical circuits have been provided for enhancing the stereo sound field, but these typically utilize complex circuitry and speaker driver configurations to create the effect. For example, U.S. Pat. No. 5,870,484 to Greenberger teaches a sound reproduction system having an array of loudspeaker transducer elements that operate in combination with signal processing circuitry to control the radiation pattern of sound radiating from the system. Signals fed to the system are manipulated by the signal processing circuitry so that the signals are each radiated in their desired directions, thereby improving spatial separation. Such approaches, however, are complex and expensive to implement, and are inappropriate for stereo systems containing a small number of loudspeaker transducer elements.

### OBJECTS AND SUMMARY OF THE INVENTION

It is therefore an object of the invention to provide an improved system and method for enhancing the stereo sound field in speaker systems.

It is one object of the invention to provide a system and method for providing enhanced stereo sound field which overcomes one or more of the limitations of the prior art.

It is a further object of the invention to provide an enhanced stereo sound effect in audio systems that include two or more speaker drivers but which do not include a subwoofer.

It is a further object of the invention to provide a system and method for enhancing the stereo sound effect without sacrificing low frequency content.

In one embodiment, the invention provides a system and method for enhancing the stereo sound effect produced by speaker systems having two or more speakers fed by two or more channels or audio, respectively. Second-order high pass filtering is applied to first and second audio signals of a stereo signal. A phase shift of approximately 180 degrees is applied to the resulting signals. A mixer mixes the processed first audio signal with the original second audio signal and mixes the processed second audio signal with the original first audio signal, whereby an expanded stereo sound field effect is created.

The disclosed system and method can be used in any audio system and is particularly useful when the audio system contains two or more speaker drivers without a subwoofer. The system and method improves the stereo field without sacrificing low frequency content.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a schematic block diagram illustrating the invention in accordance with one embodiment.

FIG. 2 shows a circuit diagram illustrating the invention in accordance with one embodiment.

FIG. 3 shows a circuit diagram illustrating the invention in accordance with one embodiment.

FIG. 4 shows a circuit diagram illustrating the invention in accordance with one embodiment.

### DETAILED DESCRIPTION OF THE PREFERRED EMBODIMENT

Reference will now be made in detail to the preferred embodiments of the present invention, examples of which are illustrated in the accompanying drawings.

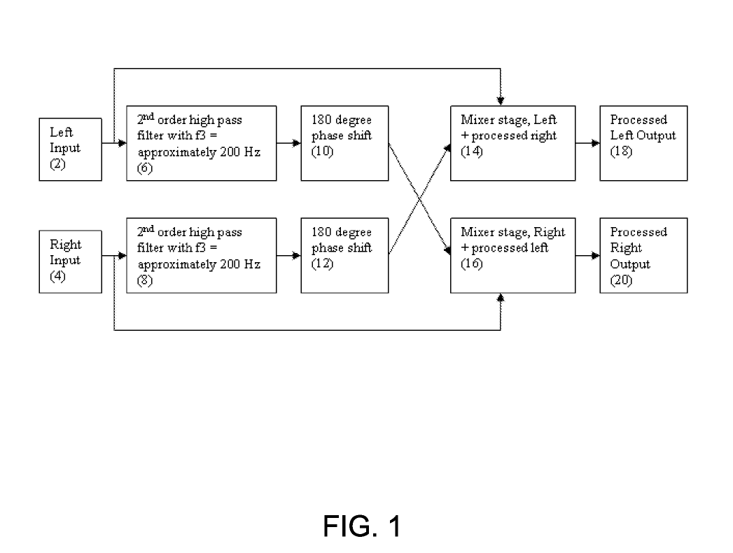

In various embodiments, the system and method uses three functional steps or blocks to accomplish the stereo sound field expansion required to recover or enhance the stereo field effect. FIG. 1 shows a block diagram which outlines the signal flow of the system in such embodiments.

The first functional block is a second-order high-pass filter. In this embodiment a first filter 6 removes frequencies below a crossover point, e.g., approximately 200 Hz, from a first audio signal 2 and a second filter 8 removes frequencies below the crossover point from a second audio signal 4, creating a first filtered audio signal and a second filtered audio signal. The first audio signal may represent a first, or left, audio channel and the second audio signal may represent a second, or right, audio signal. The frequency chosen for the crossover point of the first filter and the second filter are set according to the acoustic requirements of the audio system in which it is implemented. In practice the frequency of the crossover point is typically set between 100 Hz and 1 kHz. The first and second filters may be the same filter, two channels of the same filter, or separate filters.

The second functional block is a phase-reverser. The phase-reverser produces a phase shift of 180 degrees in this embodiment. A phase shift other than 180 degrees would not constitute a departure from the scope and spirit of the invention, particularly where the phase shift provided is nearly 180 degrees. A first phase-reversing component 10 reverses a phase of the first filtered audio signal, producing a first phase-reversed signal. A second phase-reversing component 12 reverses a phase of the second filtered audio signal, producing a second phase-reversed signal. Of course, the first and second phase-reversing components may be provided in the form of a single component, multiple channels of a single component, or multiple discrete components, without departing from the spirit and scope of the invention. As will be recognized by those of ordinary skill in the art, and as will be apparent from the description further below, the phase reversing function could be performed by a variety of analog or digital electrical components.

The third functional block is a mixer stage. A first mixer 14 mixes the first audio signal with the second phase-reversed audio signal, i.e., the processed signal from the other channel of the stereo audio signal. Likewise, a second mixer 16 mixes the second audio signal with the first phase-reversed audio signal. In one embodiment, the mixing ratio, in the first mixer 14 of the first audio signal to the second phase-reversed processed audio signal is 1:1.65. Similarly, the mixing ratio in the second mixer 16 can be set to 1:1.65. In practice, the mixing ratio is set between 1:0.2 to 1:2.3 in accordance with the acoustic requirements of the stereo system in which the system is implemented. The first and second mixers may be the same mixer, first and second channels of the same discrete device, or multiple discrete devices.

In this embodiment the first audio signal and the second audio signal may be comprised of analog audio signals or digital audio signals. As will be recognized by those of ordinary skill in the art, the functions performed by each of the functional blocks of FIG. 1 may be performed in separate steps by separate discrete electronic devices or a single discrete electronic device. When the first audio signal and the second audio signal are digital audio signals, the embodiment may be implemented via a single discrete electronic device such as a digital signal processor, a series of digital signal processors representing each functional block of the embodiment, or a combination thereof. Furthermore, digital implementation of this embodiment may be practiced through software, or a combination of software and hardware, that performs the functions of the functional blocks described in this embodiment.

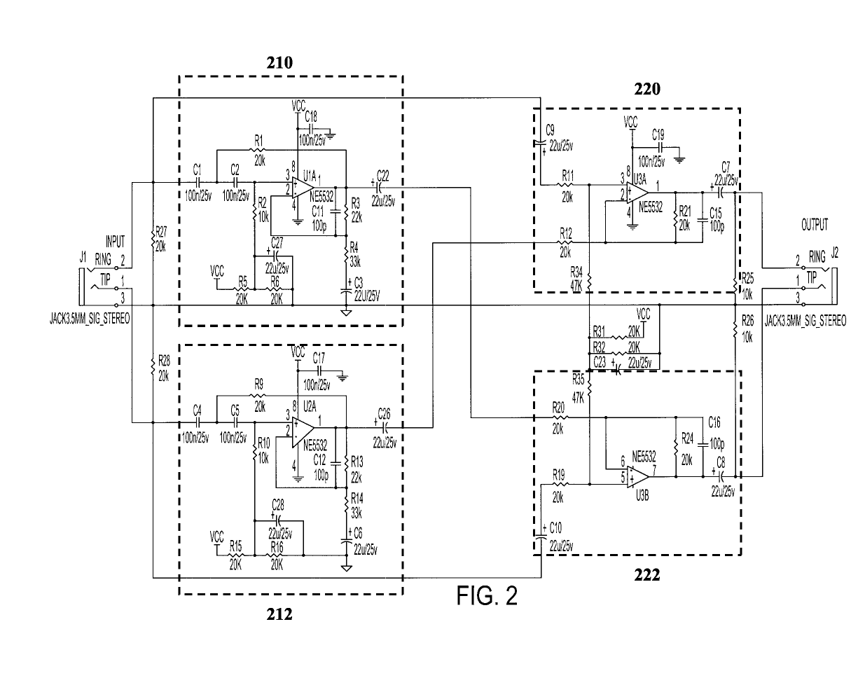

FIG. 2 is a schematic illustrating an analog embodiment of the sound field expansion system. In the embodiment shown, the phase-reversing component and mixer are combined to reduce the component count for more cost-effective and integrated implementation.

In this embodiment, a first electronic filtering component 210 is comprised of an op-amp in a second-order Sallen-Key high pass filter configuration. Suitable op-amps include, e.g., the NE5532 dual op-amp available from Fairchild Semiconductor Corporation of Irving, Tex. Of course, any component capable of operating as a second-order high-pass filter could be used as appropriate for the particular application. In this embodiment the first electronic filtering component 210 removes frequencies below a crossover point, e.g., approximately 150 Hz, from a first audio signal, producing a first filtered audio signal. A second electronic filtering component 212 is provided using identical or analogous hardware to accomplish the filtering function on a second audio signal, producing a second filtered audio signal. The crossover point for the first electronic filtering component 210 may be set by selecting appropriate values for C1, C2, R1, and R2. The crossover point for the second electronic filtering component 212 may be set by selecting appropriate values for C4, C5, R9, and R10.

In the embodiment shown, a single component is utilized to perform the functions of the first and second electronic phase-reversing devices and the first and second mixers. In this embodiment, a first electronic phase-reversing device and a first mixer comprise a single first electronic mixing device 220. Similarly a second electronic phase-reversing device and a second mixer may comprise a single second electronic mixing device 222. In this embodiment, each single electronic mixing device is comprised of an op-amp in a difference amplifier configuration. The op-amp of the first single electronic mixing device 220 and the op-amp of the second single electronic mixing device 222 are implemented by a single NE5532 dual op-amp integrated circuit. As will be recognized by those of ordinary skill in the art, the function of the single electronic mixing device may be performed by a plurality of electrical components or a discrete component that perform a phase-reversing and mixing function, either in a single operation or multiple successive operations without departing from the spirit and scope of the invention. The first single electronic mixing device 220 reverses the phase of the second filtered audio signal and mixes it with the first audio signal. The second single electronic mixing device 222 reverses the phase of the first filtered audio signal and mixes it with the second audio signal. In this embodiment, the mixing ratio of original audio signal to processed audio signal is 1:165. In practice the mixing ratio is set between 1:0.2 to 1:2.3 in accordance with the acoustic requirements of the stereo system in which this system is implemented. In this embodiment, the mixing ratio of the first single electronic mixing device 220 is determined by the ratio of resistance of a first processed signal gain resistor R12 and a first unprocessed signal gain resistor R11. Similarly, the mixing ratio of the second electronic mixing device 222 is determined by the ratio of resistance of a second processed signal gain resistor R20 and a second unprocessed signal gain resistor R19.

Of course, the component values shown in FIG. 2 are exemplary for a particular embodiment, and will vary in accordance with the specific application.

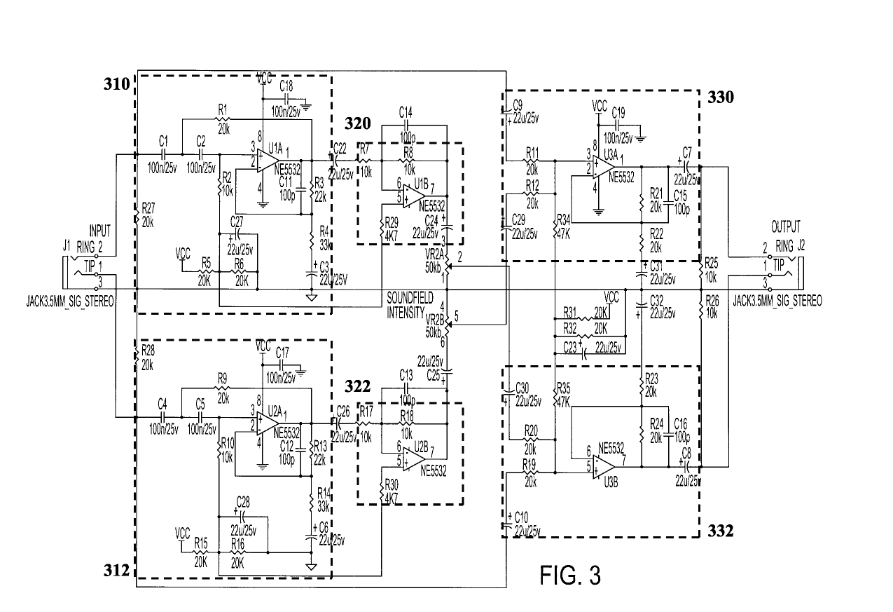

FIG. 3 shows a schematic illustrating one embodiment for practicing the sound field expansion system. This embodiment is similar to the embodiment of FIG. 2, but the mixing ratio in each mixer is variable through the adjustment of a potentiometer.

In this embodiment, a first electronic filtering component 310 comprises an op-amp in a second-order Sallen-Key high pass filter configuration. Of course, any second-order high-pass filter could be used as appropriate for the particular application. In this embodiment the first electronic filtering component removes frequencies below a crossover point, e.g., approximately 150 Hz, from a first audio signal, producing a first filtered audio signal. A second electronic filtering component 312 is provided using analogous hardware to accomplish the same filtering function on a second audio signal, producing a second filtered audio signal. The crossover point for the first electronic filtering component 310 is determined by the values of C1, C2, R1, and R2. The crossover point for the second electronic filtering component 312 is determined by the values of C4, C5, R9, and R10.

In this embodiment a first electronic phase-reversing device 320 is comprised of an op-amp in a phase reversing configuration. As will be recognized by those of ordinary skill in the art, the function of the electronic phase-reversing device may be performed by electronic devices other than an op-amp in an all pass filter configuration without departing from the spirit and scope of the invention. The first electronic phase-reversing device 320 changes the phase of the first filtered audio signal by 180 degrees to produce a first phase-reversed signal. A second electronic phase-reversing device 322 is provided using analogous hardware to accomplish the same phase-reversing function on the second filter audio signal, producing a second phase-reversed signal.

In this embodiment the op-amp of the first electronic filtering component 310 and the op-amp of the first electronic phase-reversing device 320 are implemented by a single NE5532 dual op-amp integrated circuit. Similarly, the op-amp of the second electronic filtering component 312 and the op-amp of the second electronic phase-reversing device 322 are implemented by a single NE5532 dual op-amp integrated circuit.

In this embodiment a first mixer 330 is comprised of an op-amp in a summing amplifier configuration. Similarly, a second mixer 332 is comprised of an op-amp in a summing amplifier configuration. The op-amp of the first mixer and the op-amp of the second mixer are implemented by a single NE5532 dual op-amp integrated circuit. As will be recognized by those of ordinary skill in the art, the functions of the first mixer and second mixer may be performed by a plurality of electrical components or a discrete component that perform a mixing function without departing from the spirit and scope of the invention. The first mixer 330 mixes the second filtered audio signal and the first audio signal. The second mixer 332 mixes the first filtered audio signal and the second audio signal. In this embodiment, the mixing ratio for the first mixer is determined by the position of a first potentiometer VR2B; the mixing ratio for the second mixer is determined by the position of a second potentiometer VR2A. Of course, the functions of the first potentiometer and the second potentiometer may be performed by any passive or active electronic device that allows for the adjustment of resistance or gain.

Of course, the component values shown in FIG. 3 are exemplary for a particular embodiment, and will vary in accordance with the particular application.

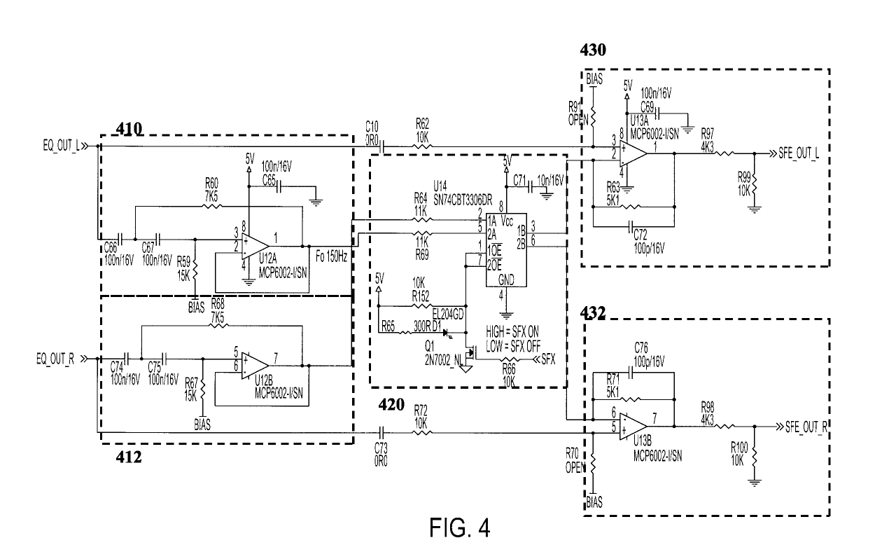

FIG. 4 is a schematic illustrating one embodiment for practicing the sound field expansion system. In this embodiment the phase-reversing component and mixer are combined to reduce the component count for more cost effective implementation. Furthermore, a means for disabling the sound field expansion system is provided.

In this embodiment, a first electronic filtering component 410 comprises an op-amp in a second order Sallen-Key high pass filter configuration. Similarly, a second electronic filtering component 412 comprises an op-amp in a second order Sallen-Key high pass filter configuration. Suitable op-amps include, e.g., the MCP6002 I/SN dual op-amp available from Microchip Technology, Inc. of Chandler, Ariz. In this embodiment the op-amp of the first electronic filtering component 410 and the op-amp of the second electronic filtering component 412 are implemented by a single MCP6002 I/SN dual op-amp integrated circuit. Of course, any second-order high-pass filter could be used as appropriate for the particular application. As will be recognized by those of ordinary skill in the art, the functions of the first electronic filtering component and the second electronic filtering component may be performed by a plurality of electrical components or a discrete component that perform a mixing function without departing from the spirit and scope of the invention. In this embodiment the first electronic filtering component 410 removes frequencies below a crossover point, e.g., approximately 150 Hz, from a first audio signal, producing a first filtered audio signal. The second electronic filtering component 412 accomplishes the same filtering function on a second audio signal, producing a second filtered audio signal. The crossover point for the first electronic filtering component 410 is determined by the values of C66, C67, R59, and R60. The crossover point for the second electronic filtering component 412 is determined by the values of C74, C75, R67, and R68.

In this embodiment a first electronic phase-reversing device and a first mixer comprise a first single electronic mixing device 430. Similarly a second electronic phase-reversing device and a second mixer may comprise a second single electronic mixing device 432. In this embodiment, each single electronic mixing device is comprised of an op-amp in a difference amplifier configuration. The op-amp of the first single electronic mixing device 430 and the op-amp of the second single electronic mixing device 432 are implemented by a single MCP6002 I/SN dual op-amp integrated circuit. As will be recognized by those of ordinary skill in the art, the single electronic mixing device may be performed by a plurality of electrical components or a discrete component that perform a phase-reversing and mixing function, either in a single operation or multiple successive operations without departing from the spirit and scope of the invention. The first single electronic mixing device 430 reverses the phase of the second filtered audio signal and mixes it with the first audio signal. The second single electronic mixing device 432 reverses the phase of the first filtered audio signal and mixes it with the second audio signal. In this embodiment, the mixing ratio of original audio signal to processed audio signal is 1:165. In practice the mixing ratio is set between 1:0.2 to 1:2.3 in accordance with the acoustic requirements of the stereo system in which this system is implemented. In this embodiment, the mixing ratio of the first single electronic mixing device 430 is determined by the ratio of resistance of a first processed signal gain resistor R64 and a first unprocessed signal gain resistor R62. Similarly, the mixing ratio of the second electronic mixing device 432 is determined by the ratio of resistance of a second processed signal gain resistor R69 and a second unprocessed signal gain resistor R72.

In this embodiment a sound field expansion switch 420 is comprised of a bus switch. Suitable bus switches include, e.g., dual FET bus switches such as the SN74CBT3306DR available from Texas Instruments Incorporated of Dallas, Tex. Of course, the switching function may be accomplished using a discrete electronic device or a plurality of electronic devices. The sound field expansion switch 420 may be used to enable or disable the stereo sound field effect during operation of the system in this embodiment. When the stereo sound field effect is enabled, the sound field expansion switch 420 allows the first filtered audio signal to communicate with the second electronic mixing device 432; and allows the second filtered audio signal to communicate with the first electronic mixing device 430.

Of course, the component values shown in FIG. 4 are exemplary for a particular embodiment, and will vary in accordance with the specific application.

While the invention has been particularly shown and described with reference to a preferred embodiment thereof, it will be understood by those skilled in the art that various changes in form and details may be made therein without departing from the spirit and scope of the invention.

The embodiments of the invention in which an exclusive property or privilege is claimed are defined as follows:

1. A method for providing an improved stereo image in an audio system, comprising:
high-pass filtering a first audio signal to create a first filtered audio signal;
high-pass filtering a second audio signal to create a second filtered audio signal;
reversing a phase of the first filtered audio signal to create a first phase-reversed audio signal;
reversing a phase of the second filtered audio signal to create a second phase-reversed audio signal;
mixing the first phase-reversed audio signal with the second audio signal; and,
mixing the second phase-reversed audio signal with the first audio signal.

2. The method of claim 1, wherein the first and second audio signals are analog audio signals.

3. The method of claim 1, wherein the first and second audio signals are digital audio signals.

4. The method of claim 1, wherein the high-pass filtering is performed by a single electronic component or a plurality of electronic components.

5. The method of claim 1, wherein the phase-reversing is performed by a single electronic component or a plurality of electronic components.

6. The method of claim 1, wherein the mixing is performed by a single electronic component or a plurality of electronic components.

7. The method of claim 1, wherein the high-pass filtering, phase-reversing, and mixing are performed by a single digital signal processor or a plurality of digital signal processors.

8. The method of claim 1, wherein the high-pass filtering is performed by software.

9. The method of claim 1, wherein the phase-reversing is performed by software.

10. The method of claim 1, wherein the mixing is performed by software.

11. The method of claim 1, wherein the high pass filtering is performed by a second-order high-pass filter.

12. The method of claim 1, wherein the high pass filtering has a crossover point that can range from 100 Hz and 1 kHz.

13. The method of claim 1, wherein the mixing has a mixing ratio of audio signal to phase-reversed audio signal that can range from 1:0.2 to 1:2.3.

14. A system for providing an improved stereo image in an audio system:
an electronic filtering device that removes a first low-frequency component of a first audio signal and a second low-frequency component of a second audio signal, whereby first and second filtered audio signals are created;
an electronic phase-reversing device which reverses a phase of the first filtered audio signal and which reverses a phase of the second filtered audio signal to create first and second phase-reversed audio signals;
a mixer configured to mix the first phase-reversed audio signal with the second audio signal, the mixer further mixing the second phase-reversed audio signal with the first audio signal.

15. The system of claim 14, wherein the first and second audio signals are analog audio signals.

16. The system of claim 14, wherein the first and second audio signals are digital audio signals.

17. The system of claim 16, wherein the electronic filtering device comprises one or more digital signal processors.

18. The system of claim 16, wherein the electronic phase-reversing device comprises one or more digital signal processors.

19. The system of claim 16, wherein the mixer comprises one or more digital signal processors.

20. The system of claim 14, wherein the electronic filtering device comprises a second-order high-pass filter.

21. The system of claim 20, wherein the second-order high-pass filter comprises an op-amp in a second order Sallen-Key high pass filter configuration.

22. The system of claim 14, wherein the electronic filtering device comprises a first electronic filtering device configured to filter the first audio signal and a second electronic filtering device configured to filter the second audio signal.

23. The system of claim 22, wherein the first electronic filtering device and the second electronic filtering device are a single integrated circuit.

24. The system of claim 22, wherein the electronic phase-reversing device comprises a first electronic phase-reversing device configured to reverse the phase of the first filtered audio signal and a second electronic phase-reversing device configured to reverse the phase of the second filtered audio signal.

25. The system of claim 24, wherein the first electronic filtering device and the first phase-reversing device are a single integrated circuit, and the second electronic filtering device and the second electronic phase-reversing device are a single integrated circuit.

26. The system of claim 14, wherein the electronic phase-reversing device comprises a first electronic phase-reversing device configured to reverse the phase of the first filtered audio signal and a second electronic phase-reversing device configured to reverse the phase of the second filtered audio signal.

27. The system of claim 14, wherein the mixer comprises an op-amp in a summing amplifier configuration.

28. The system of claim 14, wherein the mixer comprises a first mixer configured to mix the first phase-reversed audio signal with the second audio signal and a second mixer configured to mix the second phase-reversed audio signal with the first audio signal.

29. The system of claim 14, wherein the mixer comprises a single electronic mixing device configured to perform the functions of the electronic phase-reversing device and the mixer.

30. The system of claim 29, wherein the single electronic mixing device comprises an op-amp in a difference amplifier configuration.

31. The system of claim 30, wherein the single electronic mixing device a first single electronic mixing device configured to reverse the phase of the first filtered audio signal and mix the first phase-reversed audio signal with the second audio signal, and a second single electronic mixing device configured to reverse the phase of the second filtered audio signal and mix the second phase-reversed audio signal with the first audio signal.

32. The system of claim 14, further comprising a switch for enabling or disabling the improved stereo image effect.
